(19) United States
(12) Patent Application Publication
(10) Pub. No.: US 2016/0061472 A1
(43) Pub. Date: Mar. 3, 2016

(54) METHOD AND DEVICE FOR CONTROLLING ROOM TEMPERATURE AND HUMIDITY

(71) Applicant: Samsung Electronics Co., Ltd., Suwon-si (KR)

(72) Inventors: Dong Seop LEE, Suwon-si (KR); Sunggeun SONG, Incheon (KR); Gunhyuk PARK, Suwon-si (KR); Sungmok SEO, Suwon-si (KR); Kwanwoo SONG, Yongin-si (KR); Hyejung CHO, Anyang-si (KR)

(21) Appl. No.: 14/829,065

(22) Filed: Aug. 18, 2015

(30) Foreign Application Priority Data
Sep. 2, 2014 (KR) 10-2014-0116194

(51) Int. Cl. F24F 11/00; G05B 15/02

(52) U.S. Cl. CPC F24F 11/006; G05B 15/02

(57) ABSTRACT

The present disclosure relates to a sensor network, Machine Type Communication (MTC), Machine-to-Machine (M2M) communication, and technology for Internet of Things (IoT). The present disclosure may be applied to intelligent services based on the above technologies. In particular, a method and device for controlling room temperature and relative humidity to which to set a heating, ventilation, and air conditioning (HVAC) system are provided. The method for controlling temperature and humidity by a temperature and humidity control device includes acquiring at least one piece of environmental information and user biometric information, determining, based on the acquired at least one piece of the environmental information and the user biometric information, control information that determines statistical information to be within a certain range, and controlling an HVAC system based on the determined control information. Accordingly, it is possible to provide a comfortable environment to a user and save energy while maintaining comfort.

### CROSS-REFERENCE TO RELATED APPLICATION(S)

This application claims the benefit under 35 U.S.C. §119(a) of Korean patent application filed on Sep. 2, 2014 in the Korean Intellectual Property Office and assigned Serial number 10-2014-0116194, the entire disclosure of which is hereby incorporated by reference.

### TECHNICAL FIELD

The present disclosure relates to a method and device for controlling temperature and humidity. More particularly, the present disclosure relates to a method and device for controlling room temperature and relative humidity to which to set a heating, ventilation, and air conditioning (HVAC) system.

### BACKGROUND

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched.

Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

Meanwhile, a temperature and humidity control device controls room temperature and relative humidity by simply receiving room temperature and relative humidity setting information from a user in real time and determining whether to activate the temperature and humidity control device based on the received information according to the related art. Accordingly, the temperature and humidity control device according to the related art controls temperature and humidity only depending on settings manually and repeatedly input by a user without considering the user's condition and the comfort experienced by the user, which causes inconvenience to the user.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and device for determining room temperature and relative humidity using statistical information determined based on environmental information and user biometric information, and controlling room temperature and humidity based on the determined room temperature and relative humidity.

In accordance with an aspect of the present disclosure, a method for controlling temperature and humidity by a temperature and humidity control device is provided. The method includes acquiring at least one piece of environmental information and user biometric information, determining, based on the acquired at least one piece of the environmental information and the user biometric information, control information that determines statistical information to be within a certain range, and controlling a heating, ventilation, and air conditioning (HVAC) system based on the determined control information.

In accordance with another aspect of the present disclosure, a device for controlling temperature and humidity is provided. The device includes a communication unit configured to receive or transmit information from or to user equipment or indoor equipment, and a control unit configured to acquire at least one piece of environmental information and user biometric information, determines, based on the acquired at least one piece of the environmental information and the user biometric information, control information that determines statistical information to be within a certain range, and control an HVAC system based on the determined control information.

In accordance with another aspect of the present disclosure, the temperature and humidity control device can determine the set room temperature and relative humidity as control information using statistical information determined based on biometric information as well as environmental information, and accordingly can provide a comfortable environment to a user and save energy while maintaining comfort.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of a temperature and humidity control system according to an embodiment of the present disclosure;

FIG. 2 is a flowchart illustrating a procedure of performing a temperature and humidity control method according to an embodiment of the present disclosure;

FIG. 3 is a diagram illustrating a correlation between statistical information indicating the thermal comfort of a room environment and the predicted percentage of dissatisfied (PPD) of a user according to an embodiment of the present disclosure;

FIG. 4 is a flowchart illustrating in detail, operation S230 in FIG. 2 according to an embodiment of the present disclosure;

FIG. 5 is a diagram illustrating a coordinate system where temperature is plotted on the x axis and relative humidity is plotted on the y axis according to an embodiment of the present disclosure;

FIG. 6 is a flowchart illustrating in detail a procedure of controlling a heating, ventilation, and air conditioning (HVAC) system by a temperature and humidity control device 100 in operation S240 according to an embodiment of the present disclosure;

FIG. 7 is a diagram illustrating a coordinate system where room temperature is plotted on the x axis and relative humidity is plotted on the y axis when there are a plurality of users according to an embodiment of the present disclosure;

FIG. 8 is a view illustrating a way to control an HVAC system based on a user's location and user biometric information according to an embodiment of the present disclosure;

FIGS. 9A, 9B, and 9C are flowcharts illustrating a procedure of controlling indoor equipment including an HVAC system based on the characteristics and biometric information of a user according to an embodiment of the present disclosure;

FIG. 10 is a flowchart illustrating a procedure of controlling indoor equipment including an HVAC system by a temperature and humidity control device 100 according to an embodiment of the present disclosure; and

FIG. 11 is a block diagram illustrating an internal structure of a temperature and humidity control device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, some elements may be exaggerated, omitted, or schematically illustrated in the accompanying drawings. Further, the size of each element does not completely reflect the actual size thereof. In the respective drawings, the same or corresponding elements are provided with the same reference numerals.

The advantages and features of the present disclosure and ways to achieve them will be apparent when reference is made to embodiments as described below in detail in conjunction with the accompanying drawings. However, the present disclosure is not limited to the various embodiments set forth below, but may be implemented in various different forms. The following embodiments are provided only to completely disclose the present disclosure and inform those skilled in the art of the scope of the present disclosure, and the scope of present disclosure is defined only by the appended claims. Throughout the specification, the same or like reference signs are used to designate the same or like elements.

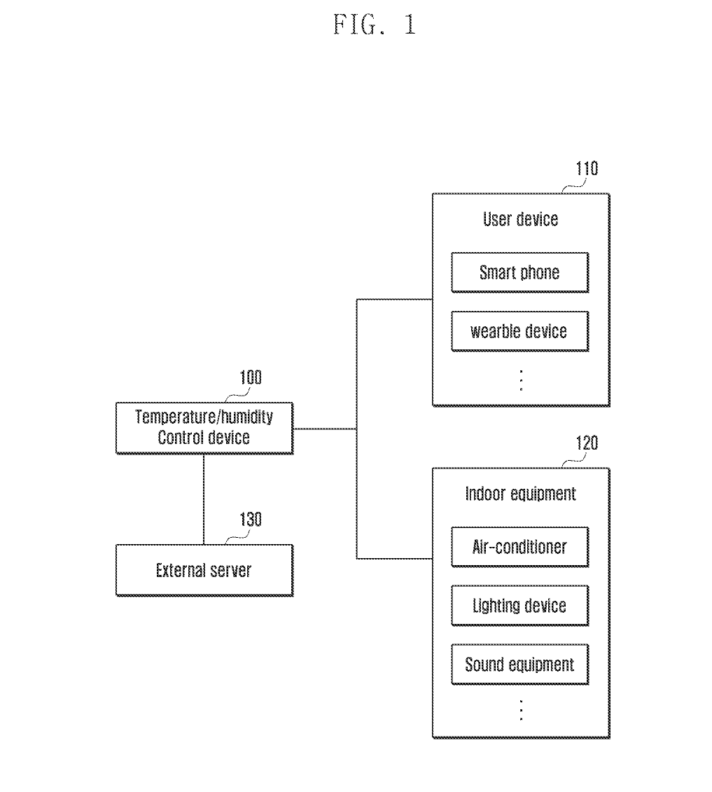

FIG. 1 illustrates a configuration of a temperature and humidity control system according to an embodiment of the present disclosure.

The temperature and humidity control system may include a temperature and humidity control device 100, at least one user equipment 110, at least one indoor equipment 120 for adjusting or maintaining room temperature, and an external server 130.

The temperature and humidity control device 100 communicates with the at least one indoor equipment 120 and the at least one user equipment 110 and centrally controls the operation of the indoor equipment 120. More specifically, the temperature and humidity control device 100 may determine the target values of set room temperature and relative humidity based on user biometric information received from the user equipment 110 and environmental information received from the external server 130 so as to control the indoor equipment 120, in particular, a heating, ventilation, and air conditioning (HVAC) system. The temperature and humidity control device 100 may determine the target values of set room temperature and humidity, which determine statistical information to be within a certain range, based on the information. The target values may be referred to as HVAC control information. The temperature and humidity control device 100 may receive the biometric information from the user equipment 110.

The temperature and humidity control device 100 may acquire the environmental information using an internal sensor provided therein. The environmental information may include room temperature, outdoor temperature, relative humidity, dew point temperature, radiant heat, airflow, and the like. The internal sensor may include a temperature detection sensor, a humidity detection sensor, a heat detection sensor, and the like.

Further, the temperature and humidity control device 100 may control the HVAC system included in the indoor equipment 120 using the determined control information. The target values of set room temperature and relative humidity may be included in the “control information” for controlling the HVAC system. The temperature and humidity control device 100 may measure the current room temperature and relative humidity through the internal sensor and then control the HVAC system to be set to the target values of the set temperature and humidity included in the control information.

The user equipment 110 may be connected to the temperature and humidity control device 100 so as to serve as a means for inputting user setting information into the temperature and humidity control device 100. The user equipment 110 may include a display unit that displays a current state of the temperature and humidity control device 100. Further, the display unit may include a touch pad that enables a user to input information with his/her finger, a touch pen, or the like. Further, the user equipment 110 may be connected to the temperature and humidity control device 100 so as to detect whether a user exists in the room. The user equipment 110 may include a mobile device such as a smart phone or include a wearable device. The wearable device is worn on a user's body and serves to transfer information on the user to the temperature and humidity control device 100. The wearable device may be a type attachable to glasses, a bracelet type, an armband type, a pendant type, or the like.

The connection between the user equipment 110 and the temperature and humidity control device 100 may be achieved by short-range wireless communication. The short-range wireless communication may, for example, include Bluetooth (BT), Wi-Fi, Wi-Fi-Direct, Zigbee, or near field communication (NFC). The user equipment 110 may transmit setting information established by the user equipment 110 to the temperature and humidity control device 100 through the short-range wireless communication. Further, the temperature and humidity control device 100 may acquire distance information between the user equipment and the temperature and humidity control device 100 based on whether the short-range wireless communication is made or disconnected.

The indoor equipment 120, which is a power consumer installed in the room, may, for example, include an air conditioner, a multi air conditioner, an HVAC system, a lighting, a refrigerator, a sensor, a pump, a fan, a boiler, control equipment for blinds and windows, and the like. The temperature and humidity control device 100 may communicate with at least one indoor equipment 120 and control the indoor equipment 120.

The temperature and humidity control device 100 may control equipment including the HVAC system by collectively considering device information and running information for the indoor equipment 120, surrounding environment condition information, and user setting information. The temperature and humidity control device 100 may receive the information related to the indoor equipment 120, the surrounding environment condition information, and the user setting information from the external server 130 and the user equipment 110. Further, the temperature and humidity control device 100 may control the operation of the indoor equipment 120.

The temperature and humidity control device 100 may receive information from the user equipment 110 and the external server 130 so as to control the indoor equipment 120. That is, the temperature and humidity control device 100, the user equipment 110, and the indoor equipment 120 may share information through a connection therebetween via a wired/wireless network, thereby creating the environment where the indoor equipment 120 and the like can be controlled in consideration of the environmental condition, user condition, and the like without the user's intervention. This is called the Internet of things (IoT). The IoT refers to an intelligent technology and service for connecting all things based on the Internet and mutually communicating information between persons, between a person and a thing, and between things. The above technology enables the temperature and humidity control device 100 to create a surrounding environment based on user biometric information and environment information without the hassle of receiving setting information input in real time from a user, thereby providing the user with a comfortable environment.

The device information provided by the external server 130 may include both information on the type of indoor equipment 120, such as, an air conditioner, control equipment for blinds and windows, and a lighting, and information on the indoor equipment 120 itself, such as, the installation location, installation time, and product serial number of the indoor equipment 120. Further, the running information may, for example, include the operation state, user, or equipment location of the indoor equipment 120, the running pattern of the indoor equipment 120 in a corresponding area, and the running history for a certain period of time.

The temperature and humidity control device 100 may acquire information for temperature and humidity control from the external server 130. The information for temperature and humidity control may include a part of the environmental information. The external server 130 may include an information providing server. The information providing server may, for example, include a meteorological agency's server. The temperature and humidity control device 100 may acquire the environmental information by receiving weather forecast information from the meteorological agency's server. That is, the temperature and humidity control device 100 may, for example, receive, from the meteorological agency's server, weather forecast information for tomorrow or several days from now and use the received information to generate control information for controlling the HVAC system at the corresponding date.

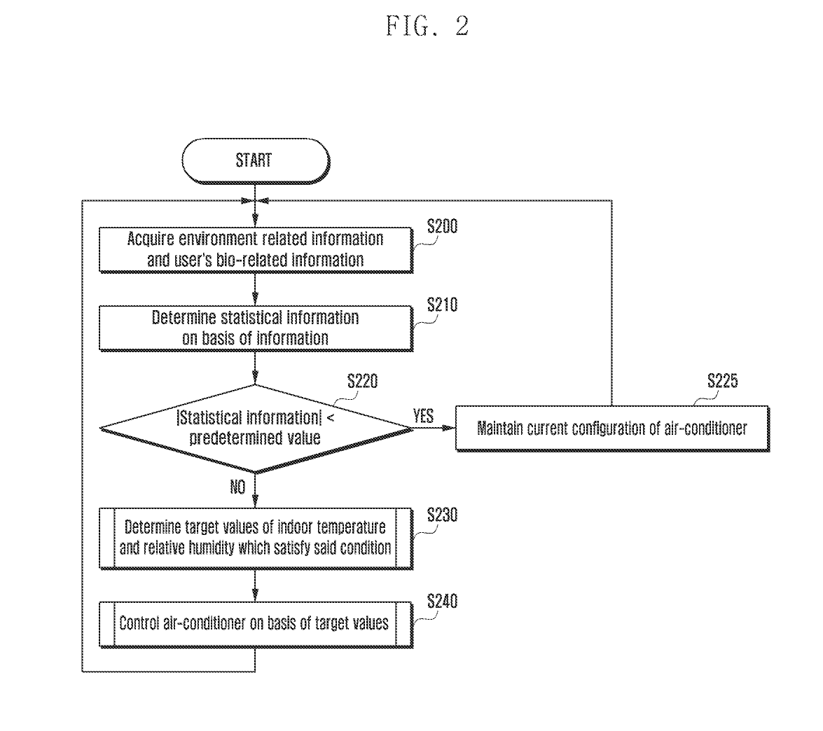

FIG. 2 illustrates a procedure of performing a temperature and humidity control method according to an embodiment of the present disclosure.

In operation S200, the temperature and humidity control device 100 acquires environmental information and user biometric information. The temperature and humidity control device 100 may acquire the environmental information using a sensor and an external server. The “environmental information” refers to information indicating various environmental indices, and control information for controlling an indoor HVAC system is determined based on the environmental information. The environmental information may, for example, include room temperature, outdoor temperature, the amount of water vapor, relative humidity, the value of radiant heat, airflow information, and the like.

The temperature and humidity control device 100 may include at least one sensor, and the sensor may include a temperature detection sensor, a vapor detection sensor, a heat detection sensor, and the like. In order to control the HVAC system, the temperature and humidity control device 100 may acquire current room temperature, outdoor temperature, and relative humidity using the sensors included therein. The relative humidity is the ratio (expressed as a percentage) of the actual water vapor amount to the saturated water vapor amount or the ratio of the actual water vapor pressure to the saturated water vapor pressure at a given temperature. The temperature and humidity control device 100 may calculate current relative humidity by acquiring information on the saturated water vapor amount at a given temperature from the external server and acquiring information on the actual water vapor amount from the sensor. Further, the temperature and humidity control device 100 may collectively process the environmental information acquired from the at least one sensor included therein.

Further, the temperature and humidity control device 100 may acquire the environmental information through sensors attached to the indoor equipment, as well as the sensors included therein. The temperature and humidity control device 100 may acquire not only environmental information in one home location but also environmental information in various home locations through sensors attached to indoor equipment installed in many indoor areas. Further, when the temperature and humidity control device 100 acquires the environmental information from the indoor equipment, the environmental information including the location information of the indoor equipment may be used to generate control information for controlling the HVAC system. The temperature and humidity control device 100 may be connected to the sensors using wireless communication in order to collect the relevant information acquired through the sensors attached to the indoor equipment. That is, the temperature and humidity control device 100 may serve as a hub device that integrates a plurality of home sensors.

The temperature and humidity control device 100 may acquire the biometric information using the user equipment 110. The “biometric information” is biometric data of a user or an occupant, based on which control information for controlling the HVAC system is determined, and may, for example, include the heart rate, body temperature, blood pressure, electrodermal response (a change in the electrical conductivity of the skin caused by an emotional response to a stimulus), and the like of a user or an occupant. Further, the “biometric information” may include information such as the age, gender, height, and weight of a user or an occupant.

The user equipment 110 may include a mobile device, such as a smart phone, or a wearable device (electronic device that a user wears on his/her body) generally used in the technical field of wireless communication. The wearable device may be attached to a user's body so as to deliver the biometric information of the user to the temperature and humidity control device 100. The wearable device may, for example, be a type attachable to glasses, a bracelet type, an armband type, a pendant type, or the like. The user equipment 110 may measure the heart rate, body temperature, blood pressure, electrodermal response, and the like of a user by means of a plurality of internal sensors included therein.

The user equipment 110 may transmit the measured biometric information to the temperature and humidity control device 100. The user equipment 110 may synthesize the user biometric information received from the plurality of internal sensors to determine the situation in which the user currently is and may use the determined situation to determine a user condition. The “user condition” may be determined based on the characteristics and biometric information of a user and may mean a general concept that refers to the physical activity, emotional state, health condition, or the like of a user. For example, the user equipment 110 may determine the current condition of a user by comparing user biometric information received in real time from the internal sensors with user biometric information stored at a previous point of time or bio-pattern information generated and stored in advance by a manufacturer. The user equipment 110 may transmit the user biometric information including the determined condition of the user to the temperature and humidity control device 100.

The temperature and humidity control device 100 may acquire environmental information and biometric information from the external server 130 and the user equipment 110 at regular time intervals, thereby updating the environmental information and the biometric information at each time operation. The regular time interval may be predetermined by a user. The user settings may be received through the user equipment 110. The temperature and humidity control device 100 may maintain a high level of comfort experienced by a user in the room by updating the environmental information and the biometric information at regular periodic intervals.

In operation S210, the temperature and humidity control device 100 determines statistical information based on the above information. A storage unit of the temperature and humidity control device 100 may pre-store data for use in determining the statistical information based on the environmental information and the biometric information. More specifically, the statistical information may be determined based on room temperature, relative humidity, an activity function, and a clothing thermal resistance function.

The “relative humidity” is the ratio (expressed as a percentage) of the actual water vapor amount to the saturated water vapor amount or the ratio of the actual water vapor pressure to the saturated water vapor pressure at a given temperature. The temperature and humidity control device 100 may calculate current relative humidity by acquiring information on the saturated water vapor amount at a given temperature from the external server and acquiring information on the actual water vapor amount from the sensor.

The “activity function” refers to the heat production of a human body per unit area, which is a concept including metabolic heat production and metabolic free energy production. The value of the “activity function” may be determined based on a heart rate included in the biometric information which has been acquired from the user equipment 110. The value of the “activity function” may be determined based on Table 1 below that is pre-stored in the temperature and humidity control device 100. The temperature and humidity control device 100 may extract the activity of a user based on the acquired heart rate and may extract the value (Watt/m²) of the “activity function” corresponding to the activity.

TABLE 1

| Activity | W/m [symbol] |
|---|---|
| Recilining, Sleeping | 4 [symbol] |
| Seated relaxed | 5 [symbol] |
| Standing at rest | 70 |
| Sedentary activity (office, dwelling, school, laboratory) | 70 |
| Car driving | 80 |
| Graphic profession - Book Binder | 85 |
| standing, light activity (shopping, laboratory, light industry) | 93 |
| Teacher | 96 |
| Domestic work -shaving, washing and dressing | 100 |
| Waiting on the level, 2 km/h | 110 |
| standing, medium activity (shop assistant, domestic work) | 116 |
| Building industry - Brick laying (Block of 16.3 kg) | 12 [symbol] |
| Washing dishes standing | 145 |
| Domestic work - raking leaves on the lawn | 170 |
| Domestic work - washing by hand and ironing (120-220 W) | 170 |
| Iron and steel - [symbol] the mould with a pneumatic hammer | 175 |
| Building industry -forming the mould | 180 |
| Waiting on the level, 6 km/h | 200 |
| Forestry -cutting across the grain with a | 20 [symbol] |
| one-man power saw | |
| Volleyball, Bicycling (16 km/h) | 222 |
| Ca [symbol] | 261 |
| Building industry - loading a wheelbarrow with stones and | 27 [symbol] |
| mortar | |
| Golf, Softball | 2 [symbol] 0 |
| Gymnastics | 319 |
| Aerobic Dancing, Swimming | 248 |
| Sports - Ice skating, 13 km/h | 260 |
| Bicycling (20 km/h) | |
| Agriculture - digging with a spade (24 [symbol] /min.) | 280 |
| Skiing on level, good snow 8 km/h | 406 |
| Backpacking, Skating ice or roller | |
| Basketball, Tennis | |
| Handball, Hockey, Racqetball, Cross County Skiing, Soccer | 464 |
| Running 12 minute | 500 |
| Forestry - working with an axe (weight 2 kg, [symbol] blows/min.) | |
| Sports - Running in 16 km/h | 550 |

[symbol]

indicates data missing or illegible when filed

Further, the value of the “clothing thermal resistance function” may be extracted from external temperature. The “clothing thermal resistance function” refers to a function that statistically indicates the ratio of the body surface area covered by clothes to the naked surface area according to temperature, and corresponds to a statistical function of external temperature. An equation for extracting the value of the “clothing thermal resistance function” according to the external temperature may be pre-stored in the temperature and humidity control device 100. The temperature and humidity control device 100 may extract the value of the “clothing thermal resistance function” from the external temperature included in the acquired environmental information.

The temperature and humidity control device 100 may determine the statistical information using data from which the acquired information including the room temperature, the outdoor temperature, and the water vapor amount, and the pre-stored information including the values of the “activity function” and the “clothing thermal resistance function” can be extracted. The statistical information may include an index indicating the thermal comfort of a room environment. The statistical information refers to a predicted mean vote (PMV) or a thermal index, which may indicate a numerically expressed value of thermal sensation which a person statistically experiences in a state where the room temperature, the relative humidity, the value of the activity function, and the value of the clothing thermal resistance function are given. The statistical information may include the PMV that is generally used in the technical field to which the present disclosure pertains. When the statistical information corresponds to the PMV, the value of the PMV may include a numerically expressed value of thermal sensation, ranging from numeral −3 (very cold) to numeral +3 (very hot).

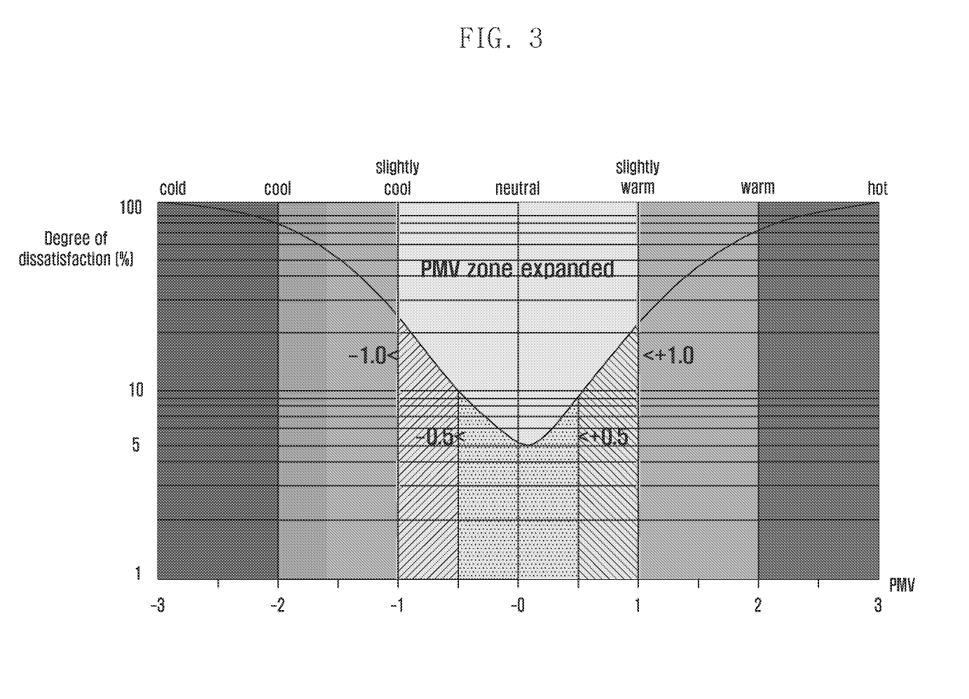

In operation S220, the temperature and humidity control device 100 determines whether the absolute value of the statistical information is in the range less than a specific value. The specific value may include a value pre-stored in the temperature and humidity control device 100. When the statistical information corresponds to the PMV, the pre-stored value may be determined based on an index indicating the predicted dissatisfaction for the PMV value. The index indicating the predicted dissatisfaction for the PMV value may include a predicted percentage of dissatisfied (PPD) (%) that is generally used in the technical field to which the present disclosure pertains. The PPD versus the PMV value is illustrated in FIG. 3.

FIG. 3 illustrates a correlation between statistical information indicating the thermal comfort of a room environment and the PPD of a user according to an embodiment of the present disclosure.

When the temperature and humidity control device 100, for example, stores the PMV value corresponding to a PPD value of 20% as the specific value for the PMV value, the PMV value may have an absolute value of less than 0.84 based on FIG. 3. Statistically, an ordinary user feels comfortable when the PPD value is equal to or less than 20%, and the above numerical value is disclosed in the American Society of Heating, Refrigeration and Air Conditioning Engineers (ASHRAE) standard falling within the general technical scope of the present disclosure. The temperature and humidity control device 100 may always provide a comfortable environment to a user by considering the above described PPD for the statistical information.

When it is determined in operation S220 that the absolute value of the statistical information is in the range less than the specific value, in operation S225, the temperature and humidity control device 100 maintains the currently set room temperature and relative humidity. This is because, when the temperature and humidity control device 100 determines the specific value based on the satisfaction of a user, as described above, the user is already in the environment where he/she feels comfortable.

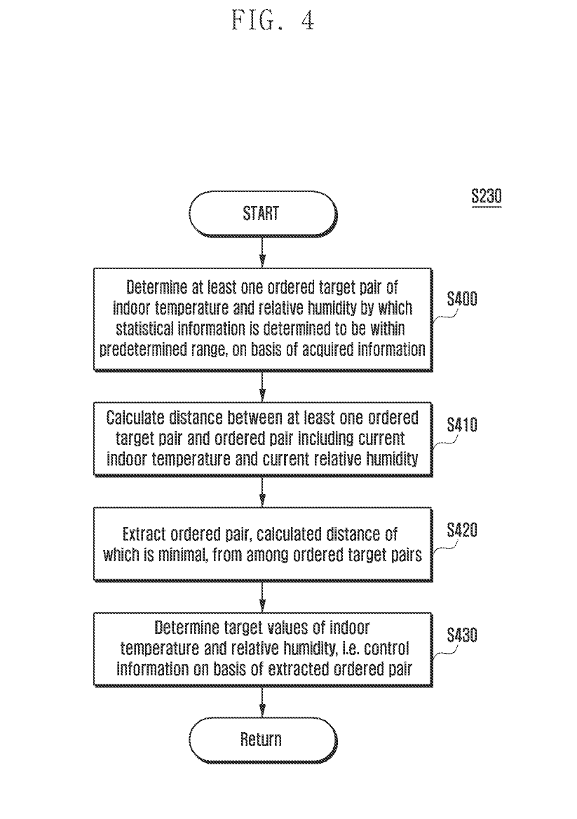

When it is determined in operation S220 that the absolute value of the statistical information is in the range out of the specific value, in operation S230, the temperature and humidity control device 100 acquires the target values of room temperature and relative humidity that satisfy the above condition. The target values of room temperature and relative humidity may correspond to “control information” based on which the HVAC system is controlled. The control information may include an ordered pair consisting of the target values of room temperature and relative humidity. A procedure of acquiring the target values of room temperature and relative humidity will be described in more detail in FIG. 4.

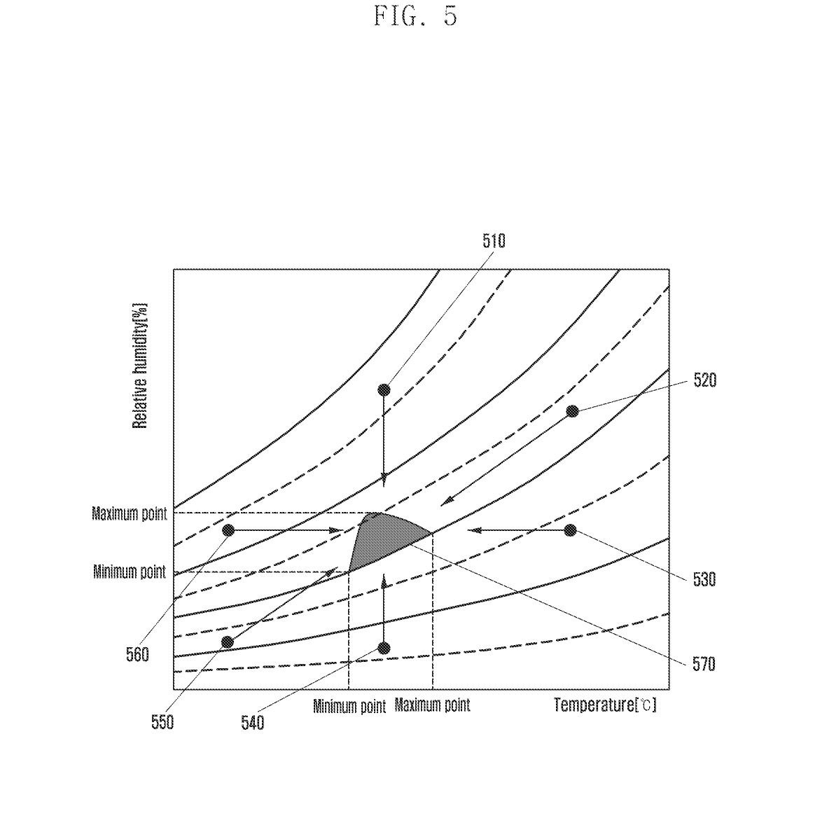

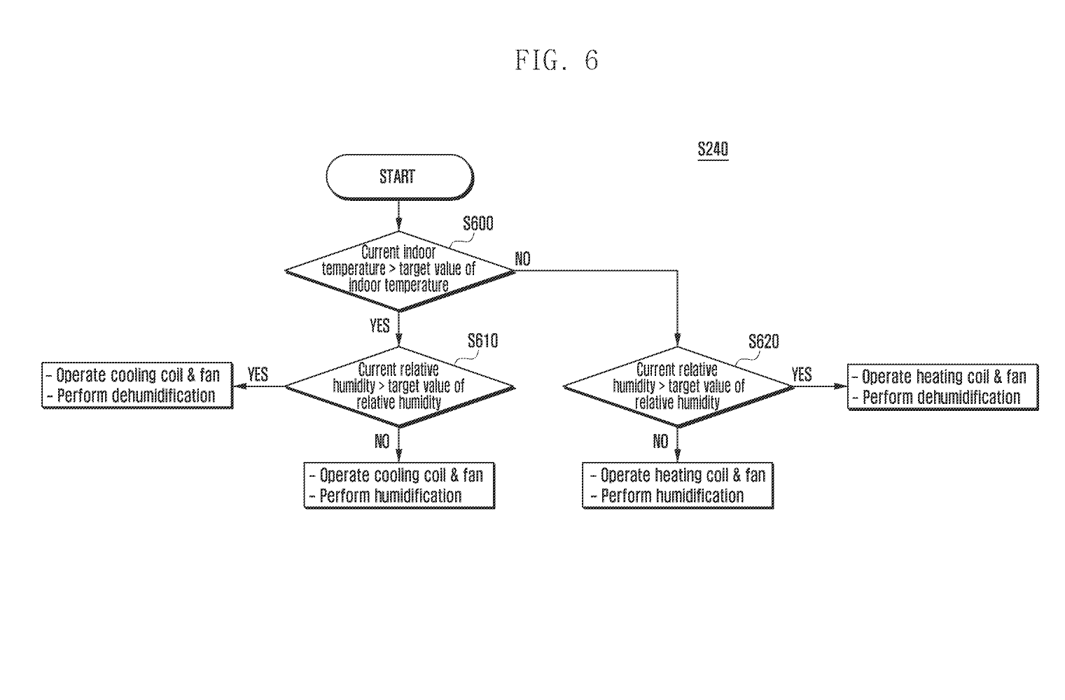

In operation S240, the temperature and humidity control device 100 controls the HVAC system based on the acquired target values of room temperature and relative humidity. The temperature and humidity control device 100 controls the HVAC system such that the current room temperature and relative humidity reach the acquired target values. A detailed procedure of controlling the HVAC system by the temperature and humidity control device 100 will be described with reference to FIGS. 5 and 6.

FIG. 4 illustrates in detail operation S230 in FIG. 2 according to an embodiment of the present disclosure.

More specifically, the temperature and humidity control device 100 determines the target values of room temperature and relative humidity that determine the absolute value of the statistical information to be less than a predetermined specific value.

In operation S400, the temperature and humidity control device 100 may acquire at least one target ordered pair of room temperature and relative humidity, which determine the statistical information to be within a certain range, based on the acquired environmental information and biometric information. More specifically, the temperature and humidity control device 100 may extract the values of the activity function and the clothing thermal resistance function using the outdoor temperature and the heart rate included in the acquired environmental information and biometric information and using the data pre-stored in the storage unit. The temperature and humidity control device 100 may acquire at least one value of room temperature and relative humidity, which determine the statistical information to be within a certain range, based on the extracted activity function and clothing thermal resistance function.

The “target ordered pair” may include an ordered pair consisting of the acquired values of room temperature and relative humidity. The certain range may include a range corresponding to the condition determined in operation S220, that is, a range where the absolute value of the statistical information is equal to or less than the specific value. The values of room temperature and relative humidity may be expressed as an ordered pair, as described above. The at least one target ordered pair may be expressed as a coordinate value having temperature as the x coordinate and relative humidity as the y coordinate. A set of the coordinate values may be represented by a given area in the above described coordinate system. As an example, for the coordinate system where the x coordinate is temperature and the y coordinate is relative humidity, a set of points having coordinates values corresponding to the target ordered pairs is represented by an area at “570” in FIG. 5. Assuming that statistical information corresponds to the PMV, reference numeral “570” in FIG. 5 indicates the area that represents a set of points having, as their coordinate values, ordered pairs of current temperature and relative humidity, which determine the PMV as a PMV value of less than 0.84, that is, the PMV value that allows the PPD to be less than 20%.

In operation S410, the temperature and humidity control device 100 calculates the distance between the at least one target ordered pair and the ordered pair consisting of current room temperature and relative humidity. The way of calculating the distance between the ordered pairs is to consider the ordered pairs as coordinate values and calculate the distance between the coordinate values. The distance between the ordered pairs may be calculated by the following equation:

l=\sqrt{(x₁−x₂)²+(y₁−y₂)²} Equation 1

In Equation 1, x₁, y₁ denote the room temperature and relative humidity in the target ordered pair, and x₂, y₂ denote the current room temperature and relative humidity respectively.

In operation S420, the temperature and humidity control device 100 extracts a target ordered pair that is smallest in distance from the ordered pair of current room temperature and relative humidity, calculated by the above equation, among the target ordered pairs. The temperature and humidity control device 100 may sort the distance values calculated in operation S410 in an ascending order and store them in the storage unit, and then may extract a target ordered pair having the smallest distance value.

In operation S430, the temperature and humidity control device 100 may determine the extracted target ordered pair as the target values of room temperature and relative humidity, that is, the control information based on which the HVAC is controlled.

The reason why the temperature and humidity control device 100 extracts a target ordered pair having the smallest distance from the ordered pair of current room temperature and relative humidity among the target ordered pairs and determines the extracted target ordered pair as the control information is because it intends to maintain user comfort and at the same time save energy. That is, if current room temperature and relative humidity fall within the area illustrated in FIG. 5, which represents target ordered pairs that allow the statistical information to be within a certain range, that is, allow the absolute value of the statistical information to be less than a specific value, then there is no difference in the comfort experienced by a user regardless of whether the current room temperature and relative humidity are located at an edge of the area or in a central portion of the area. Therefore, the temperature and humidity control device 100 may maintain user comfort and at the same time save the energy used for controlling the HVAC system within the comfort range by setting the target values to values located at the edge of the area, that is, values having little difference from current room temperature and relative humidity, if possible, and controlling the HVAC system using the set target values.

FIG. 5 illustrates a coordinate system where temperature is plotted on the x axis and relative humidity is plotted on the y axis according to an embodiment of the present disclosure.

More specifically, in a coordinate system where temperature is plotted on the x axis and relative humidity is plotted on the y axis, an ordered pair of current room temperature and relative humidity may be represented by a point (reference numerals “510”, “520”, “530”, “540”, “550”, and “560”). Further, a set of at least one target ordered pair of room temperature and relative humidity that determine the statistical information to be within a certain range may be represented by an area (reference numeral “570”).

Using the coordinate system, reference will be made to a method for controlling the HVAC system by the temperature and humidity control device 100. The temperature and humidity control device 100 controls the HVAC system such that the point 510, 520, 530, 540, 550, or 560 corresponding to the ordered pair of current room temperature and relative humidity can be close to the area 570 corresponding to the set of the target ordered pairs. A detailed control method will be described with reference to FIG. 6.

FIG. 6 illustrates in detail a procedure of controlling an HVAC system by a temperature and humidity control device 100 in operation S240 according to an embodiment of the present disclosure.

The temperature and humidity control device 100 determines a control method for the HVAC system by comparing the determined control information, that is, the target values of set room temperature and relative humidity with current room temperature and relative humidity. First, the temperature and humidity control device 100 determines in operation S600 whether the current room temperature is higher than the target value of room temperature included in the control information, and determines in operations S610 and S620 whether the current relative humidity is higher than the target value of relative humidity included in the control information. Depending on the determinations in operations S600 to S620, the temperature and humidity control device 100 operates a cooling coil and a fan when the current room temperature is higher than the target value of room temperature included in the control information, and operates a heating coil and a fan when the current room temperature is lower than the target value of room temperature included in the control information. Further, the temperature and humidity control device 100 activates a dehumidification function when the current relative humidity is higher than the target value of relative humidity included in the control information, and activates a humidification function when the current relative humidity is lower than the target value of relative humidity included in the control information.

Further, the temperature and humidity control device 100 may control the HVAC system in accordance with the difference between the target value of set room temperature and the current room temperature and the difference between the target value of relative humidity and the current relative humidity. More specifically, the temperature and humidity control device 100 may determine the degree of control of the HVAC system in proportion to the distance measured when the ordered pair consisting of the target values of set room temperature and relative humidity and the ordered pair consisting of the current room temperature and relative humidity are considered coordinate values. For example, the greater the distance between the ordered pair of the current room temperature and relative humidity and the ordered pair of the target values of set room temperature and relative humidity included in the control information, the higher the degree of control of the HVAC system.

The degree of control of the HVAC system may be controlled by fixing the time it takes for the current room temperature and relative humidity to reach the target values of set room temperature and relative humidity, regardless of the current room temperature and relative humidity. As an example, for the point 510 or 520, if the time it takes to reach the area 570 is fixed to the same value, regardless of the distance between the point 510 or 520 and the area 570, then the level of operation of the cooling coil and the fan of the HVAC system may be increased for the point 520.

The temperature and humidity control device 100 may control the HVAC system in accordance with the difference between the target value of set room temperature and the current room temperature and the difference between the target value of relative humidity and the current relative humidity, thereby consistently providing a comfortable environment to a user. In FIG. 5, the greater the distance from the area 570 where the absolute value of the statistical information is less than the specific value, that is, the PPD is less than a predetermined value, the less comfort that a user experiences. That is, the point 520 that is farther away from the area 570 than the point 540 corresponds to the environment where a user experiences discomfort.

In this situation, if the time it takes to reach the area 570 is fixed to the same value for any point, as described above, then it takes the same time for either of a user in the environment corresponding to the point 540 and a user in the environment corresponding to the point 520 to reach the comfortable environment. Accordingly, a user can be prevented from staying long in the environment where he/she experiences discomfort.

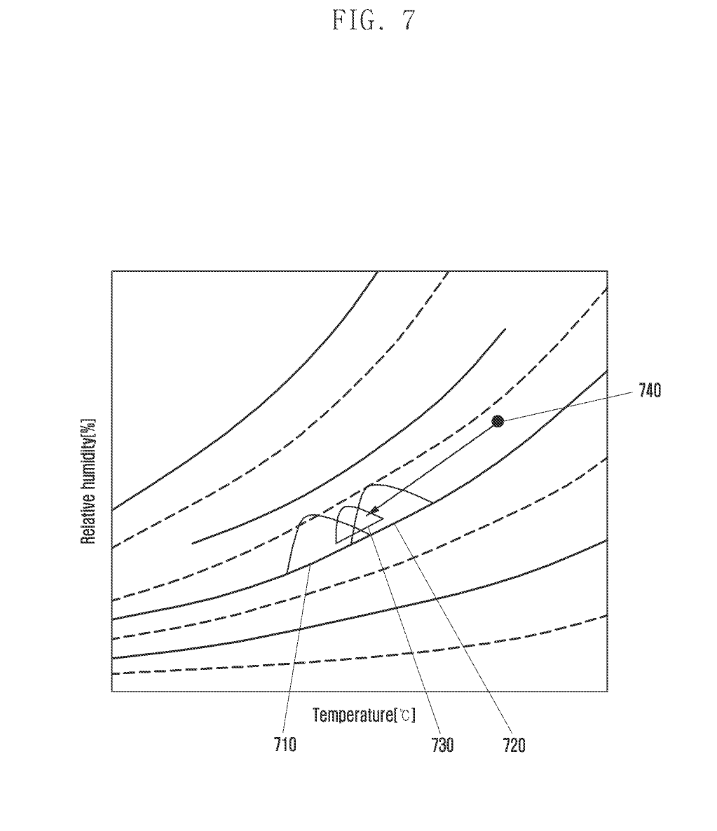

FIG. 7 illustrates a coordinate system where room temperature is plotted on the x axis and relative humidity is plotted on the y axis when there are a plurality of users according to an embodiment of the present disclosure.

More specifically, in a coordinate system where temperature is plotted on the x axis and relative humidity is plotted on the y axis, an ordered pair of current room temperature and relative humidity may be represented by a point (740). When there are a plurality of users, a plurality of pieces of biometric information are acquired in operation S200 of FIG. 2. Accordingly, the temperature and humidity control device 100 may determine, for each user, a different set of at least one target ordered pair consisting of room temperature and relative humidity, which determine control information to be within a certain range, based on the acquired biometric information. As a result, in the coordinate system where room temperature is plotted on the x axis and relative humidity is plotted on the y axis, an area consisting of points having the target ordered pairs as their coordinate values may be represented for each user.

For each user, the area consisting of points having the target ordered pairs as their coordinate values is indicated by reference numerals “710”, “720”, and “730”. For example, it is assumed that the at least one target ordered pair of room temperature and relative humidity that determine the control information to be within a certain range is an ordered pair of room temperature and relative humidity that allow the PMV value to be less than 0.84. The area 710 may correspond to a range of room temperature and relative humidity where the PMV value for adult males is less than 0.84, the area 720 may correspond to a range of room temperature and relative humidity where the PMV value for adult females is less than 0.84, and the area 730 may correspond to a range of room temperature and relative humidity where the PMV value for juveniles is less than 0.84.

The temperature and humidity control device 100 may receive information on a user who is selected to be considered in controlling the HVAC system, among the plurality of users. Any one of the plurality of users may input the information on the selected user into the temperature and humidity control device 100 through the user equipment 110. The default value of the information on the selected user may be set for all users of the HVAC system. The temperature and humidity control device 100 or the user equipment 110 may display user information on the display unit. A user may touch or otherwise select the displayed user information, thereby inputting information on a user who is selected to be considered in controlling the HVAC system.

The temperature and humidity control device 100 acquires the target ordered pair only for the selected user. As a result, in the coordinate system where set temperature is plotted on the x axis and set relative humidity is plotted on the y axis, an area consisting of a set of points having the target ordered pairs as their coordinate values is represented only for the selected user. The temperature and humidity control device 100 finally extracts target ordered pairs constituting an area corresponding to the intersection of the areas represented for each user.

That is, among the target ordered pairs acquired for each selected user, the temperature and humidity control device 100 extracts those that are in common to the users and finally determine control information based on the extracted target ordered pairs. As an example, when the area consisting of a set of points having, as their coordinate values, the target ordered pairs acquired for each selected user includes the areas 720 and 730, the temperature and humidity control device 100 extracts, as the final target ordered pairs, the coordinate values of the area corresponding to the intersection of the areas 720 and 730. Subsequently, the temperature and humidity control device 100 determines the target values of room temperature and relative humidity, that is, the control information for the HVAC system, in the same manner as in operations S410 to S430 of FIG. 4. And, the temperature and humidity control device controls an HVAC system based on the target value of room temperature and relative humidity, in the same manner as in operations of FIG. 6.

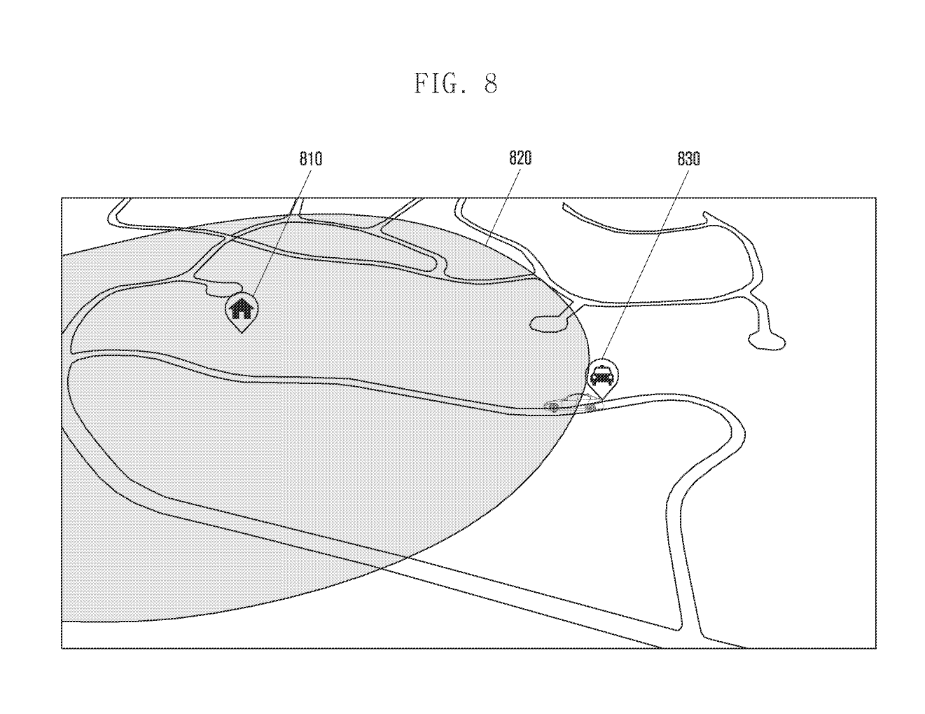

FIG. 8 illustrates a way to control an HVAC system based on a user's location and user biometric information according to an embodiment of the present disclosure.

More specifically, reference numeral “810” indicates a range that is within a predetermined distance from a building where the temperature and humidity control device 100 is located, and reference numeral “820” indicates a range that is within a second predetermined distance from the building. Reference numeral “830” indicates a user.

The temperature and humidity control device 100 may acquire information on the distance between the temperature and humidity control device 100 and the user. The temperature and humidity control device 100 may use connectivity between the temperature and humidity control device 100 and the user equipment 110 as a means for acquiring the distance information. The user equipment 110 may include a smart phone or a wearable device (electronic device that a user wears on his/her body) generally used in the technical field to which the present disclosure pertains. The wearable device may be a type attachable to glasses, a bracelet type, an armband type, a pendant type, or the like. The connectivity may include short-range wireless communication. The short-range wireless communication may include BT, Wi-Fi, Wi-Fi-Direct, Zigbee, or NFC.

The temperature and humidity control device 100 may measure the distance between the temperature and humidity control device 100 and the user equipment 110 using the wireless communication connectivity. Further, when the measured distance is equal to or greater than the predetermined distance, the temperature and humidity control device 100 may detect that the user is absent from the room or the user is out. The user may input the predetermined distance through any of the user equipment 110. Further, when there is no input from the user, the default value of the predetermined distance may be set to a distance that covers the range with respect to the building where the temperature and humidity control device 100 is located.

Further, when the measured distance is equal to or less than the predetermined distance, the temperature and humidity control device 100 may detect this and accordingly control the HVAC system. Further, when it is detected that the user is within the second predetermined distance, the temperature and humidity control device 100 may control the HVAC system based on the environment information, the user biometric information, and the distance. The second predetermined distance has a greater value than the predetermined distance.

For example, when it is detected that the user is within the second predetermined distance after the operation of the HVAC system is stopped because the connectivity is disrupted or it is detected that the user is not within the predetermined distance, the temperature and humidity control device 100 may begin to operate the HVAC system such that heating/cooling or dehumidification/humidification is previously performed in consideration of the time it takes until the user is within the predetermined distance.

Further, when it is detected that the user is within a certain distance from the temperature and humidity control device 100, the temperature and humidity control device 100 may acquire environmental information and user biometric information and accordingly control the operation of the HVAC system. The temperature and humidity control device 100 may determine statistical information based on the above information. More specifically, the statistical information may be determined based on room temperature, relative humidity, an activity function, and a clothing thermal resistance function. The “activity function” and the “clothing thermal resistance function” are the same as described above. The temperature and humidity control device 100 may determine whether the absolute value of the statistical information is in the range less than a specific value. Assuming that the statistical information corresponds to the PMV, the range less than the specific value may be a range where the absolute value of the PMW is less than 0.84. This is the same as described above in FIG. 2.

When it is determined that the absolute value of the statistical information is in the range out of the specific value, the temperature and humidity control device 100 may determine, based on the “activity function” and the “clothing thermal resistance function”, the target values of room temperature and relative humidity that determine the absolute value of the statistical information to be less than the predetermined specific value. The temperature and humidity control device 100 may determine the acquired room temperature and relative humidity as control information and control the HVAC system based on the control information. The temperature and humidity control device 100 may control the HVAC system such that current room temperature and relative humidity reach the target values of room temperature and relative humidity included in the control information.

In contrast to the case where the user is within the predetermined distance, when the user is between the predetermined distance and the second predetermined distance, the temperature and humidity control device 100 may control the HVAC system based on the distance between the temperature and humidity control device 100 and the user. The temperature and humidity control device 100 may use the distance and user motion information to predict the time when the user is to be within the predetermined distance. The user “motion information” may be acquired through a motion sensor provided in any of the user equipment 110. The “motion information” may include information on the average moving speed of the user. The temperature and humidity control device 100 may control the HVAC system from the current point of time such that the current room temperature and relative humidity reach the room temperature and relative humidity included in the control information at the time when the user is to be within the predetermined distance.

The temperature and humidity control device 100 may previously detect the user's biometric information through the user equipment 110 including the user's wearable device before the user is within the predetermined distance, for example, before the user returns home, and then may predict the time when the user is to be within the predetermined distance and accordingly control the HVAC system. On account of this, the comfort experienced by the user can be maximized without a need for temperature/humidity settings for each event and schedule settings. Further, since the time when the user is to be within the predetermined distance is predicted as described above, it is possible to save the energy consumed to keep the room, from which the user is absent, comfortable before the user is within the predetermined distance. In other words, the temperature and humidity control device 100 can maximize energy saving as far as the user experiences comfort.

Hereinafter, an embodiment of the present disclosure will be described. The temperature and humidity control device 100 may control other indoor equipment such as a lighting device, a sound device, a ventilation device, and an air cleaner, as well as the HVAC system in the indoor equipment 120 based on the acquired environmental information and biometric information. This corresponds to a technology belonging to the above-mentioned field of IoT.

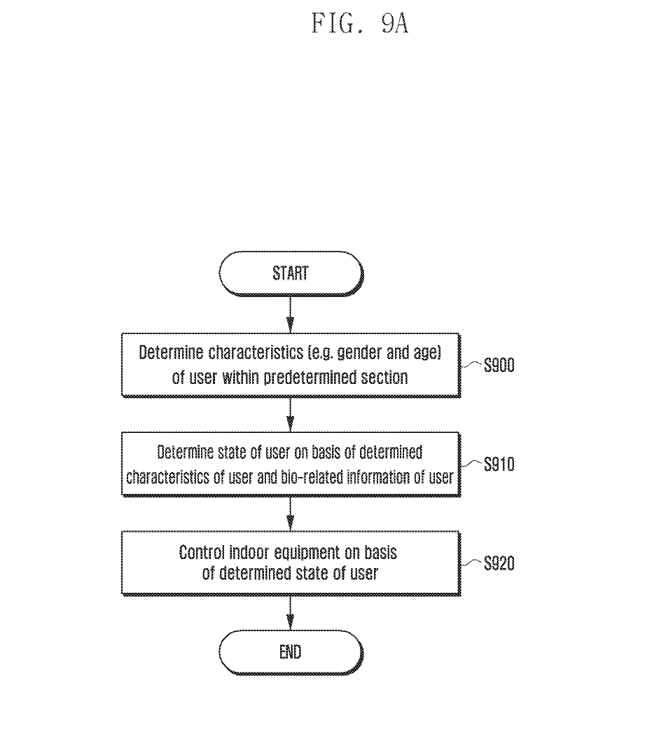

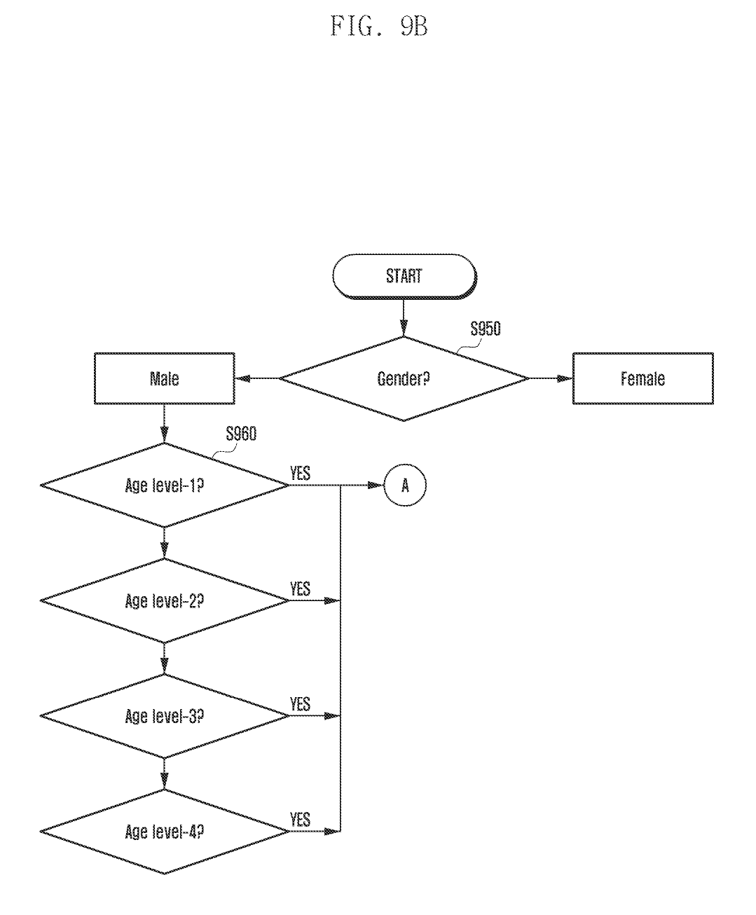

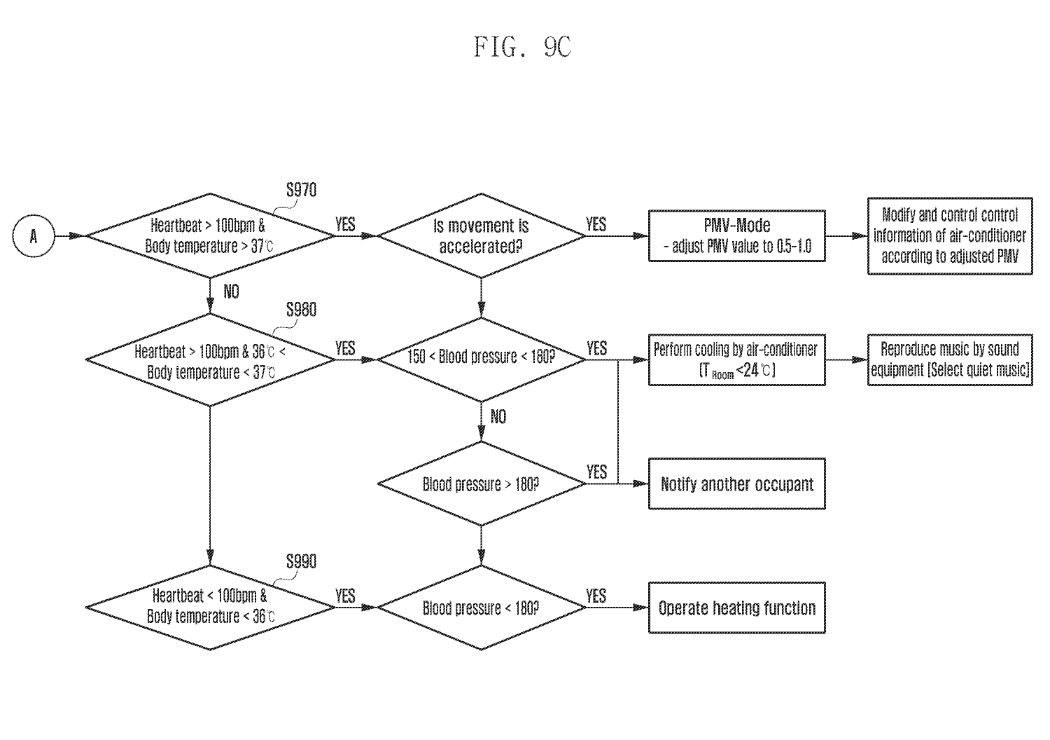

FIGS. 9A, 9B, and 9C illustrate a procedure of controlling indoor equipment including an HVAC system based on the characteristics and biometric information of a user according to an embodiment of the present disclosure.

More specifically, FIG. 9A illustrates a procedure of controlling an HVAC system by the temperature and humidity control device 100 based on biometric information including the characteristics of a user, and FIGS. 9B and 9C illustrate examples of controlling the HVAC system using the above method.

Referring to FIG. 9A, in operation S900, the temperature and humidity control device 100 acquires information on the characteristics of a user who is within the predetermined distance. The “user characteristics” may, for example, include the gender, age, height, weight, or basal metabolic rate of the user. The user characteristics may be previously input by the user through the user equipment 110, and the temperature and humidity control device 100 may acquire the user characteristics from the user equipment 110.

In operation S910, the temperature and humidity control device 100 determines a user condition based on the characteristics and biometric information of the user. The temperature and humidity control device 100 may receive the current biometric information of the user from the user equipment 110. The user condition may be determined as any of user conditions pre-stored in the temperature and humidity control device 100. The “user condition” may be determined based on the characteristics and biometric information of the user and may mean a general concept that refers to the physical activity, emotional state, health condition, or the like of the user. The user condition may include information indicating whether the user is exercising, whether the user is melancholy, whether the user catches a cold, whether the user suffers from indigestion, and the like.

More specifically, using the user characteristic information received from the user equipment 110, the temperature and humidity control device 100 determines a range of biometric information to be used as criteria for determining the user condition. For example, whether the user is exercising is determined as the user condition using the user biometric information, the temperature and humidity control device 100 may determine the threshold value of a heart rate according to whether the gender of the user is male or female and determine whether the user is exercising based on the determined threshold value. For example, the threshold value of a heart rate for a male may be generally determined to be lower than the threshold value of a heart rate for a female. Further, the temperature and humidity control device 100 may determine the threshold value of the user biometric information according to the age of the user characteristics.

The temperature and humidity control device 100 may determine the user condition by estimating the acquired user biometric information based on the determined threshold value of the user biometric information to be used for the determination of the user condition. A more specific example will be given below in FIG. 9B.

In operation S920, the temperature and humidity control device 100 controls the indoor equipment based on the determined user condition. Information for controlling the indoor equipment based on the user condition may be pre-stored in the storage unit of the temperature and humidity control device 100. The temperature and humidity control device 100 may determine the user condition and then control the indoor equipment based on the pre-stored information.

Alternatively, the temperature and humidity control device 100 may determine the current user condition by acquiring user biometric information using a plurality of internal sensors included in the user equipment 110 and synthesizing the user biometric information received from the plurality of internal sensors. For example, the user equipment 110 may determine the current user condition by comparing user biometric information received in real time from the internal sensors with user biometric information stored at a previous point of time or bio-pattern information generated and stored in advance by a manufacturer. Alternatively, the user equipment 110 may determine the user condition using various methods used when the temperature and humidity control device 100 determines the user condition. The user equipment 110 may transmit the result of the determination to the temperature and humidity control device 100.

FIG. 9B illustrates an example of a method for controlling equipment including an HVAC system by the temperature and humidity control device 100.

The temperature and humidity control device 100 may control the equipment including the HVAC system based on user characteristics and biometric information. First, the temperature and humidity control device 100 receives, from the user equipment 110, information on the characteristics of a user who is detected to be within a predetermined distance from the temperature and humidity control device 100. In operations S950 and S960, the temperature and humidity control device 100 determines the gender and age of the user from the information of the characteristics of the user in that order. The temperature and humidity control device 100 may determine the age of the user using age level classification.

FIG. 9C illustrates a method for controlling equipment including an HVAC system when a user corresponds to meal age level 1.

In operation S970, the temperature and humidity control device 100 uses the determined age level to determine the threshold value of the user biometric information to be used for determining a user condition. For example, in the case of a user corresponding to male age level 1, the temperature and humidity control device 100 may determine the threshold value of a heart rate as 100 bpm (beats per minute) and determine the threshold value of body temperature as 37° C., wherein the heart rate and the body temperature are used to determine whether the user (occupant) is exercising. If the user is a female, then the temperature and humidity control device 100 may determine the threshold values of the heart rate and the body temperature as lower values than for the male user.

When the heart rate and body temperature of the user are higher than the threshold values determined on based the user characteristics, the temperature and humidity control device 100 determines whether the motion of the user is accelerated. Whether the motion of the user is accelerated may be measured using a motion acceleration sensor included in the user equipment 110. If the motion acceleration sensor in the user equipment 110 detects the motion of the user, then the user equipment 110 transmits such detection information to the temperature and humidity control device 100. Upon receiving the detection information from the user equipment 110, the temperature and humidity control device 100 may determine whether the user is exercising. When it is determined that the user is exercising, the temperature and humidity control device 100 may control the equipment including the HVAC system based on information pre-stored in the storage unit. As an example, when it is determined that the user is exercising, the temperature and humidity control device 100 may set, as target values, that is, as control information, room temperature and relative humidity that allow the PMV, which may be included in statistical information, to have a value ranging from −0.5 to −1.0, and accordingly control the HVAC system.

Further, the temperature and humidity control device 100 may divide the room into a plurality sections and determine, for each section, whether a user exists, and may control the HVAC system and the indoor equipment located in a section for which it is determined that a user exists. The temperature and humidity control device 100 may be connected to a motion detection sensor, an indoor sound detection sensor, and an indoor light detection sensor located in the corresponding section so as to determine, for each section, whether a user exists. Further, the temperature and humidity control device 100 may use sensors, which are provided in the indoor equipment located in each home area, as described above, to determine, for each area, whether a user stays in the room. When the indoor sound detection sensor continuously detects a sound lower than a predetermined threshold sound level (decibel) over a period of time longer than a predetermine threshold time, the temperature and humidity control device 100 may detect that no occupant stays in the room. When the indoor light detection sensor continuously detects light lower than a predetermined threshold illuminance (Lx) over a period of time longer than a predetermine threshold time, the temperature and humidity control device 100 may detect that no occupant stays in the room. The temperature and humidity control device 100 may acquire the predetermined threshold value and the predetermined threshold time by user settings. A user may input the threshold value and the threshold time into the temperature and humidity control device 100 using the user equipment 110.

When it is determined using the sensors that no user exists in a specific section, the temperature and humidity control device 100 may stop the operation of the HVAC system or power off the equipment. The temperature and humidity control device 100 may control indoor equipment located in the section where the HVAC system is received based on information pre-stored in the storage unit. For example, the temperature and humidity control device 100 may receive information on the amount of carbon dioxide and the level of fine dust from a detection sensor and the like located in the specific section and control the equipment in the corresponding section based on the received information. Further, the temperature and humidity control device 100 may control the equipment in the specific section based on environmental information received from the sensors that are provided in the indoor equipment located in each home area, as described above. As an example, upon receiving information indicating that the amount of carbon dioxide in the specific section is greater than a predetermined threshold value, the temperature and humidity control device 100 may activate a ventilation device located in the specific section. As another example, upon receiving information indicating that the level of fine dust in the specific section is higher than a predetermined threshold value, the temperature and humidity control device 100 may activate an air cleaner located in the specific section.

On a section by section basis, the temperature and humidity control device 100 may receive environmental information through sensors located in a specific section and control the indoor equipment including the HVAC system based on the received information, thereby providing a user with comfort in a more detailed manner. Further, since the control of the indoor equipment including the HVAC system is made only for the specific section, it is possible to prevent the indoor equipment located in a section where no user exists from being unnecessarily operated, and thus save energy.

The temperature and humidity control device 100 may control the indoor equipment based on environmental information and user biometric information. The information based on which the indoor equipment is controlled may be pre-stored in the storage unit of the temperature and humidity control device 100. Basically, the temperature and humidity control device 100 may analyze the acquired information and accordingly control the equipment so as to provide a comfortable environment to a user.

As an example, information for controlling equipment so as to provide a comfortable sleep environment to a user may be pre-stored in the temperature and humidity control device 100, which will now be described in detail. Using a sensor located in a specific section, the temperature and humidity control device 100 may detect a section where a user exists. The temperature and humidity control device 100 may determine whether the user is asleep through the acquired user biometric information. For example, the temperature and humidity control device 100 may determine whether the user is asleep using a motion sensor and the like in the user equipment 110. When it is determined that the user is asleep, the temperature and humidity control device 100 may automatically control a blinds control device, a lighting device, and an HVAC system located in the section where the user exists based on the pre-stored information. As an example, the temperature and humidity control device 100 may lower the blinds using the blinds control device, dim the lighting device, and control the set room temperature and relative humidity of the HVAC system. Further, when a wake-up alarm function is previously set, the temperature and humidity control device 100 may automatically turn on the lighting device and play back alarm music while adjusting the sound volume.

For example, the temperature and humidity control device 100 may control the equipment according to the pre-stored information so as to create an environment where the user can be prevented from catching a disease (e.g., asthma or atopic allergy). To avoid fine dust, cold temperature and humidity that may cause asthma, the temperature and humidity control device 100 may detect fine dust, room temperature, and relative humidity using sensors located in home and then control the indoor equipment according to the pre-stored information. Further, the temperature and humidity control device 100 may receive information on the level of fine dust and the level of yellow sand on the date on which to control temperature and humidity from a meteorological agency's server that is an external server connected to the temperature and humidity control device 100 and control the indoor equipment according to the pre-stored information.

For example, the temperature and humidity control device 100 may control the equipment according to the pre-stored information so as to create the environment where the constitution of the user can be improved. When diabetes or heavy weight is input as the user's disease into the user characteristic information or a high blood glucose level is detected through the user equipment 110, the temperature and humidity control device 100 may acquire such information. In this case, the temperature and humidity control device 100 may control the set room temperature and humidity of the HVAC system according to the pre-stored information so as to create the environment where an increase in blood glucose can be blocked and body fat can be easily burnt. Further, the temperature and humidity control device 100 not only may provide a user-adaptive environment, but also may be connected to a local hospital's server so as to transmit user biometric information to the server. Further, the temperature and humidity control device 100 may receive information for establishing the environment suitable for a diseased user from the local hospital's server connected thereto. Accordingly, since a medical team can take care of the user even during a period of time when the user is not admitted to the hospital, the treatment for the disease can be effective and the medical team can also provide a medical service of good quality.

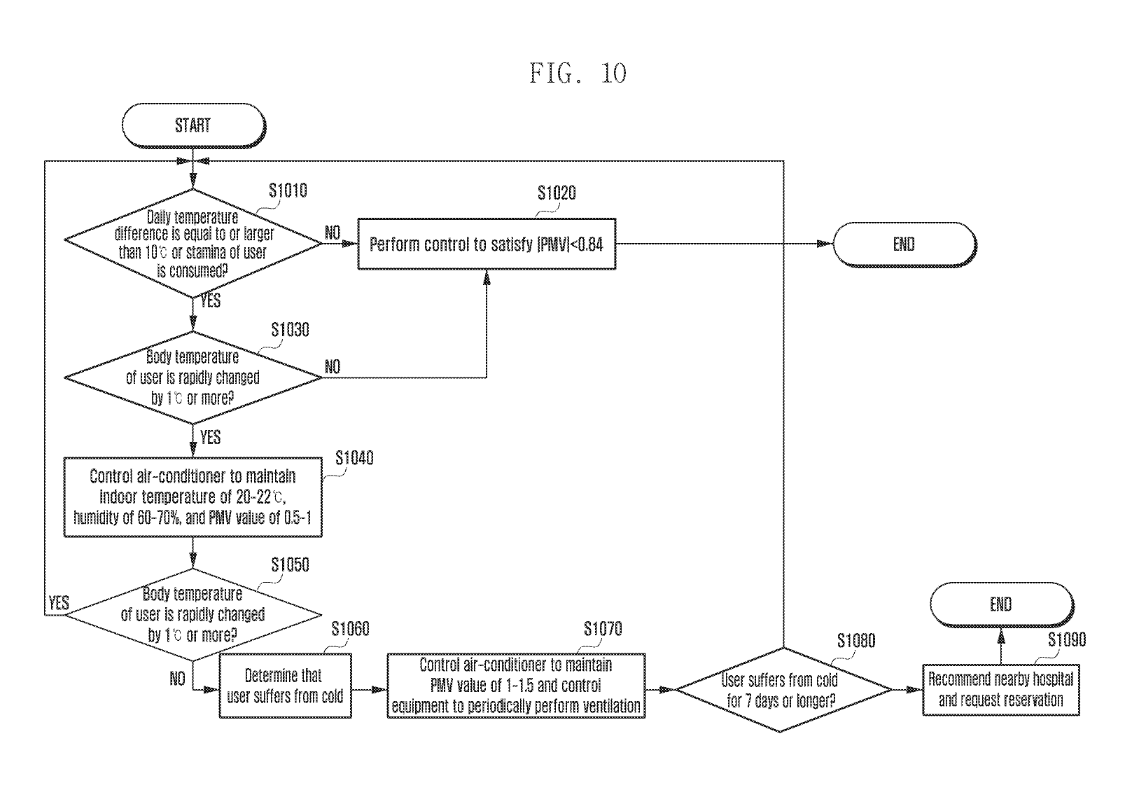

FIG. 10 illustrates a procedure of controlling indoor equipment including an HVAC system by a temperature and humidity control device 100 according to an embodiment of the present disclosure.

The storage unit of the temperature and humidity control device 100 may store an algorithm as shown in FIG. 10 so that the temperature and humidity control device 100 can control the equipment according to the algorithm. In operation S1010, the temperature and humidity control device 100 determines, from acquired environment information and biometric information, whether the daily temperature range exceeds 10° C. or physical exhaustion occurs. When it is determined that the daily temperature range does not exceed 10° C. and no physical exhaustion occurs, in operation S1020, the temperature and humidity control device 100 may determine control information having the target values of room temperature and relative humidity that determine the PMV value to be less than 0.84 and may control the HVAC system based on the determined control information. When it is determined that the daily temperature range exceeds 10° C. or physical exhaustion occurs, in operation S1030, the temperature and humidity control device 100 determines whether the user suffers from a sudden body temperature change of greater than 1° C. When there is no change in the body temperature of the user, the temperature and humidity control device 100 returns to operation S1020 and controls the HVAC system in the same way.

When it is determined that the user suffers from a sudden body temperature change of greater than 1° C., in operation S1040, the temperature and humidity control device 100 may adjust the room temperature and relative humidity to 20 to 22° C. and 60 to 70% respectively or control the room temperature and relative humidity so as to maintain the PMV value to 0.5 to 1. Further, the temperature and humidity control device 100 determines in operation S1050 whether the body temperature of the user is subsequently maintained in a range of 36.5±0.5° C., and when the body temperature of the user is in the corresponding range, returns to the first operation, that is, operation S1010 and repeats the above procedure. Further, when the body temperature of the user is not maintained in a range of 36.5±0.5° C., the temperature and humidity control device 100 may determine in operation S1060 that the user develops symptoms of a cold, control in operation S1070 the HVAC system so as to maintain the PMV value to 1 to 1.5, and periodically ventilate the room by using an indoor window control device or activating a ventilation device.

Further, the temperature and humidity control device 100 may continue to determine whether the user develops symptoms of a cold by repeatedly performing operations S1010 to S1050, and when it is determined in operation S1080 that the symptoms of a cold last seven days or longer, may display information for recommending a nearby hospital to the user equipment 110 or request the hospital's server for an appointment by transmitting corresponding information to the server in operation S1090. Further, the temperature and humidity control device 100 may transmit the biometric information of the user to the hospital at which the user has made an appointment.

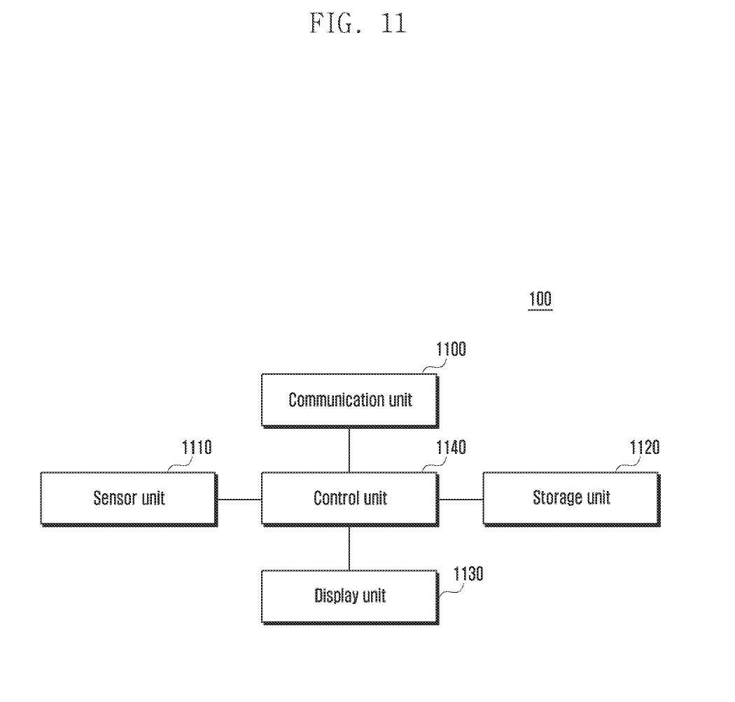

FIG. 11 illustrates an internal structure of a temperature and humidity control device according to an embodiment of the present disclosure.

As shown in FIG. 11, the temperature and humidity control device 100 may include a communication unit 1100, a sensor unit 1110, a storage unit 1120, a display unit 1130, and a control unit 1140.

The communication unit 1100 may be connected to the user equipment 110, the indoor equipment 120, and the external server 130 so as to transmit or receive information used for temperature and humidity control. The connectivity between the communication unit 1100 and the user equipment 110 may include short-range wireless communication. The short-range wireless communication may include BT, Wi-Fi, Wi-Fi-Direct, Zigbee, or NFC. The connectivity between the communication unit 1100 and the user equipment 110 may be used as a means for acquiring distance information between the temperature and humidity control device 100 and the user. The communication unit 1100 may receive biometric information from the user equipment 110. Further, the communication unit 1100 may receive environmental information from sensors attached to the indoor equipment. Further, the communication unit 1100 may be connected to the external server 130, for example, a meteorological agency's server, and may receive, from the external server 130, weather forecast information on the date on which to control the indoor equipment including the HVAC system.

Further, the communication unit 1100 may transmit equipment control information to the indoor equipment 120. The equipment control information may include the set room temperature and relative humidity of the HVAC system. The communication unit 1100 may receive information for temperature and humidity control from the external server 130. The information for temperature and humidity control may include, as a part of the environmental information, information on the saturated water vapor amount at a given temperature. The communication unit 1100 may receive information on the indoor equipment 120 from the external server 130. The external server 130 from which the information on the indoor equipment 120 is transmitted may include the equipment manufacturer's server.

The sensor unit 1110 may acquire indoor and outdoor environmental information around the temperature and humidity control device 100. The sensor unit 1110 may, for example, include a temperature sensor, a humidity sensor, a light sensor, a motion sensor, a sound detection sensor, and the like. The sensor unit 1110 may measure the ambient environment through the sensors so that the temperature and humidity control device 100 can acquire the environment information. The environmental information may, for example, include at least one of room temperature, the amount of water vapor, irradiation, radiant heat, airflow, and wind speed. Further, the sensor unit 1110 may detect whether a user exists in a specific section using the sensors.

The storage unit 1120 stores information used for the temperature and humidity control device 100 to control temperature and humidity. The storage unit 1120 may store the acquired environment information and user biometric information. The storage unit 1120 may store control information, which determines statistical information to be within a certain range, based on the above information. The storage unit 1120 may store information received from any other external server 130. The storage unit 1120 may transmit the stored information to the control unit so that the control unit can use the information.

The storage unit 1120 may store information used for the temperature and humidity control device 100 to control the indoor equipment including the HVAC system based on the environmental information and biometric information. The information used to control the indoor equipment may be in the form of a pre-stored algorithm.

The display unit 1130 may display information used for the temperature and humidity control device 100 to control temperature and humidity. The display unit 1130 may display room temperature, outdoor temperature, humidity, irradiation, and the like detected by the sensor unit 1110. The display unit 1130 may indicate whether the statistical information is currently less than a specific value. That is, when the statistical information corresponds to the PMV and the specific value corresponds to an absolute PMV value of 0.84, the display unit 1130 may indicate whether a user is statistically in a comfortable condition.

The display unit 1130 may display the determined target values of set room temperature and relative humidity, that is, control information based on which the HVAC system is controlled. When there is a plurality of users, the display unit 1130 may display information on a user who is selected to be considered in controlling the HVAC system. The display unit 1130 may be in the form of a touchpad so as to receive the information of the selected user from the user.

The control unit 1140 controls the method for controlling temperature and humidity by the temperature and humidity control device 100. The control unit 1140 may acquire at least one piece of environmental information and user biometric information; determine, based on the acquired information, control information that determines statistical information to be within a certain range; and control the HVAC system based on the determined control information.

Before acquiring the information, the control unit 1140 acquires the distance information between the temperature and humidity control device and the user, and when the acquired distance information is within a predetermined distance, controls the HVAC system based on the environmental information, the biometric information, and the distance information. Before acquiring the information, the control unit 1140 detects, for each section, whether a user exists in the corresponding section, and controls the HVAC system only for the section where the existence of the user has been detected.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for controlling temperature and humidity by a temperature and humidity control device, the method comprising:
acquiring at least one piece of environmental information and user biometric information;
determining, based on the acquired at least one piece of the environmental information and the user biometric information, control information that determines statistical information to be within a certain range; and
controlling a heating, ventilation, and air conditioning (HVAC) system based on the determined control information.

2. The method of claim 1, wherein the statistical information comprises information that indicates a numerically expressed value of thermal sensation statistically experienced by the user based on the at least one piece of the environmental information and the user biometric information.

3. The method of claim 1, wherein the environmental information comprises at least one of current room temperature, current outdoor temperature, and current relative humidity.

4. The method of claim 3, wherein the determining of the control information comprises acquiring at least one target ordered pair of room temperature and relative humidity, which determine the statistical information to be within a certain range, based on the outdoor temperature and the user biometric information.

5. The method of claim 4, wherein the determining of the control information comprises:
calculating a distance between the at least one target ordered pair and an ordered pair consisting of the current room temperature and the current relative humidity;
extracting, among the at least one target ordered pair, an ordered pair that is smallest in the calculated distance; and
determining the control information based on the extracted ordered pair.

6. The method of claim 5, wherein the controlling of the HVAC system comprises controlling the HVAC system such that a time it takes for the current room temperature and the current relative humidity to reach room temperature and relative humidity included in the extracted ordered pair corresponds to a predetermined time.

7. The method of claim 4, wherein, if there is a plurality of users, the determining of the control information comprises:
receiving information on a user who is selected to be considered in controlling the HVAC system, among the plurality of users;
acquiring target ordered pairs for each selected user;
extracting, among the target ordered pairs acquired for each selected user, target ordered pairs that are in common to the selected users; and
determining the control information based on the extracted target ordered pairs.

8. The method of claim 1, further comprising:
before acquiring the at least one piece of the environmental information and the user biometric information, acquiring distance information between the temperature and humidity control device and the user; and
if a distance in the acquired distance information is within a predetermined distance, controlling the HVAC system based on the environmental information, the biometric information, and the distance information.

9. The method of claim 1, further comprising:
before acquiring the information, detecting, for each section, whether a user exists in the corresponding section; and
controlling the HVAC system only for the section where the existence of the user has been detected.

10. The method of claim 1, wherein the acquiring of the at least one piece of environmental information comprises acquiring the at least one environmental information from sensors attached to at least one indoor equipment.

11. A device for controlling temperature and humidity, the device comprising:
a communication unit configured to receive or transmit information from or to user equipment or indoor equipment; and
a control unit configured to:
acquire at least one piece of environmental information and user biometric information,
determine, based on the acquired at least one piece of the environmental information and the user biometric information, control information that determines statistical information to be within a certain range, and
control a heating, ventilation, and air conditioning (HVAC) system based on the determined control information.

12. The device of claim 11, wherein the statistical information comprises information that indicates a numerically expressed value of thermal sensation statistically experienced by the user based on the at least one piece of the environmental information and the user biometric information.

13. The device of claim 11, wherein the environmental information comprises at least one of current room temperature, current outdoor temperature, and current relative humidity.

14. The device of claim 13, wherein to determine the control information, the control unit is further configured to:
acquire at least one target ordered pair of room temperature and relative humidity, which determine the statistical information to be within a certain range, based on the outdoor temperature and the user biometric information.

15. The device of claim 14, wherein to determine the control information, the control unit is further configured to:
calculate a distance between the at least one target ordered pair and an ordered pair consisting of the current room temperature and the current relative humidity,
extract, among the at least one target ordered pair, an ordered pair that is smallest in the calculated distance, and
determine the control information based on the extracted ordered pair.

16. The device of claim 15, wherein to control the HVAC system, the control unit is configured to:
control the HVAC system such that a time it takes for the current room temperature and the current relative humidity to reach room temperature and relative humidity included in the extracted ordered pair corresponds to a predetermined time.

17. The device of claim 15, wherein, if there is a plurality of users, to determine the control information, the control unit is further configured to:
receive information on a user who is selected to be considered in controlling the HVAC system, among the plurality of users,
acquire target ordered pairs for each selected user,
extract, among the target ordered pairs acquired for each selected user, target ordered pairs that are in common to the selected users, and
determine the control information based on the extracted target ordered pairs.

18. The device of claim 11, wherein, before acquiring the at least one piece of the environmental information and the user biometric information, the control unit is further configured to:
acquire distance information between the temperature and humidity control device and the user, and
if a distance in the acquired distance information is within a predetermined distance, control the HVAC system based on the environmental information, the bio metric information, and the distance information.

19. The device of claim 11, wherein, before acquiring the information, the control unit is further configured to:
detect, for each section, whether a user exists in the corresponding section, and
control the HVAC system only for the section where the existence of the user has been detected.

20. The device of claim 11, wherein the control unit is further configured to acquire the at least one environmental information from sensors attached to at least one indoor equipment.
